(19) United States
(12) Patent Application Publication
(10) Pub. No.: US 2025/0348045 A1
(43) Pub. Date: Nov. 13, 2025

(54) APPARATUS, METHOD, AND NON-TRANSITORY COMPUTER READABLE MEDIUM

(71) Applicant: Yokogawa Electric Corporation, Tokyo (JP)

(72) Inventors: Hideo UEMURA, Tokyo (JP); Hirohisa INOUE, Tokyo (JP)

(21) Appl. No.: 19/203,177

(22) Filed: May 9, 2025

(30) Foreign Application Priority Data
May 13, 2024 (JP) 2024-078191

(51) Int. Cl. G05B 13/02

(52) U.S. Cl. CPC G05B 13/0265

(57) ABSTRACT

Provided is an apparatus including: an acquisition unit which acquires state data regarding a facility; a selection unit which selects, among a plurality of learning models that output a control parameter to be applied to a control target in the facility, a recommended learning model recommended to be used for control of the control target in order to adapt a KPI regarding the facility to a reference condition, based on the state data acquired by the acquisition unit, in response to supply of state data regarding the facility; and an output unit which outputs identification information of the recommended learning model.

The contents of the following patent application(s) are incorporated herein by reference: NO. 2024-078191 filed in JP on May 13, 2024.

### BACKGROUND

### 1. Technical Field

The present invention relates to an apparatus, a method, and a non-transitory computer readable medium.

### 2. Related Art

Patent Document 1 and the like describe that “comprising: a candidate model storage unit configured to store a plurality of candidate models each of which is generated by reinforcement learning . . . and is capable of outputting an action according to the state of the facility; . . . a model selection unit configured to select an object model for controlling the controlled object from among the plurality of candidate models based on the plurality of indicators; . . . ” (claim 1 of Patent Document 1).

### Prior Art Document

### Patent Document

Patent Document 1: Japanese Patent Application Publication No. 2023-173459
Patent Document 2: Japanese Patent Application Publication No. 2021-174259
Patent Document 3: Japanese Patent Application Publication No. 2014-2579
Patent Document 4: Japanese Patent Application Publication No. 2022-117730
Patent Document 5: Japanese Patent Application Publication No. 2021-72049

### BRIEF DESCRIPTION OF THE DRAWINGS

FIG. 1 illustrates a system 1 according to the present embodiment.

FIG. 2 illustrates an operation of a control support apparatus 4.

FIG. 3 illustrates a change in state data acquired by an acquisition unit 401.

FIG. 4 illustrates a difference in profit depending on a switching timing of a target learning model 420(T).

FIG. 5 illustrates a transition of “AI selection-based profit” and “user selection-based profit”.

FIG. 6 illustrates an example of a computer 1200 in which a plurality of aspects of the present invention may be entirely or partially embodied.

### DESCRIPTION OF EXEMPLARY EMBODIMENTS

Hereinafter, embodiments of the present invention will be described. However, the following embodiments are not for limiting the invention according to the claims. In addition, not all of the combinations of features described in the embodiments are imperative to the solving means of the invention.

### Configuration of System 1

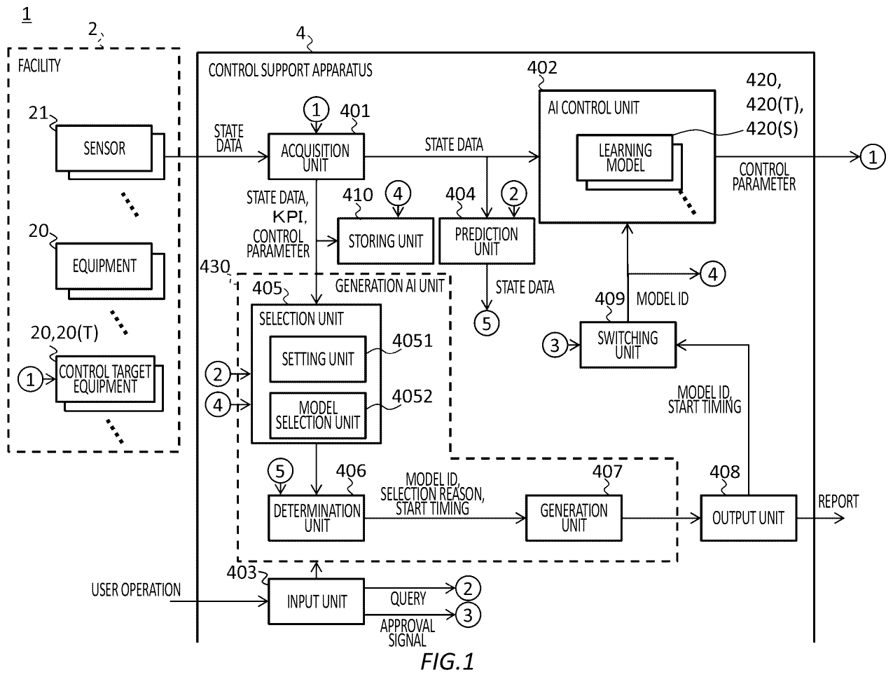

FIG. 1 shows a system 1 according to the present embodiment. The system 1 includes a facility 2 and a control support apparatus 4.

### Facility 2

The facility 2 is equipped with a plurality of pieces of equipment 20. For example, the facility 2 may be a plant or may be a composite apparatus in which a plurality of pieces of equipment 20 are combined. Examples of the plant may include a plant for managing and controlling wells such as a gas field and an oil field and surroundings thereof, a plant for managing and controlling hydroelectric, thermo electric and nuclear power generations and the like, a plant for managing and controlling environmental power generation such as solar power and wind power, a plant for managing and controlling water and sewerage, a dam, and the like, in addition to chemical and bio industrial plants and the like. In the present embodiment, as an example, the facility 2 has one or more pieces of equipment 20 and one or more sensors 21.

### Equipment 20

Each piece of equipment 20 is an instrument, machinery, or an apparatus, may be, for example, an actuator, that is, an operation end such as a valve, a pump, a heater, a fan, a motor, a switch, or the like that controls at least one physical quantity of pressure, temperature, pH, speed, flow rate, or the like in a process of the facility 2, and performs a given operation corresponding to a manipulated variable. However, the equipment 20 is not limited thereto, and may be, for example, a controller that controls an operation end.

In the present embodiment, as an example, the facility 2 is provided with a plurality of pieces of equipment 20. The equipment 20 may be of different types or at least two or more pieces of equipment 20 among them may be of the same type.

Each piece of equipment 20 may be controlled by a wired communication or wireless communication from outside via a network (not illustrated) or may be controlled manually. Note that the term “control” used in the present specification may be broadly construed to include indirect control of the operation end via the controller in addition to direct control of the operation end.

At least some pieces of equipment 20 of the plurality of pieces of equipment 20 may be control targets (also referred to as control target equipment 20(T)) to be controlled by the control support apparatus 4. In a case where the system 1 is provided with a plurality of pieces of control target equipment 20(T), the plurality of pieces of control target equipment 20(T) may have a relationship in which they are controlled in conjunction with each other (for example, a master-servant relationship, a relationship in which they are not controlled independently). In addition, the control target equipment 20(T) may be the same type of equipment 20 or may be different types of equipment 20.

### Sensor 21

Each sensor 21 measures a state regarding the facility 2. The state regarding the facility 2 may be a state of the facility 2 itself or may be a state of a product of the facility 2. The state of the facility 2 itself may be, for example, the internal pressure, flow rate, temperature, pH, speed, power consumption, or concentration of the facility 2, and may be a state indicating a process variable as an example. The state regarding the facility 2 may be the temperature or humidity of the external environment of the facility 2, sunshine, wind direction, wind volume, precipitation, or the like, may be the consumption amount of energy or raw materials by the facility 2, may be the amount of greenhouse gas emissions, or may be yield, production cost, or the like. The state of the product may be preset quality (for example, purity, concentration, composition, viscosity, color, or the like) or may be a production amount. Each sensor 21 may supply the state data obtained by the measurement to the control support apparatus 4.

### Control Support Apparatus 4

The control support apparatus 4 supports the control of the facility 2. The control support apparatus 4 may be one or more computers, and may be constituted by a PC or the like. The control support apparatus 4 includes an acquisition unit 401, an AI control unit 402, an input unit 403, a prediction unit 404, a selection unit 405, a determination unit 406, a generation unit 407, an output unit 408, a switching unit 409, and a storing unit 410.

### Acquisition Unit 401

The acquisition unit 401 acquires various types of information regarding the facility 2. For example, the acquisition unit 401 may acquire state data regarding the facility 2. The acquisition unit 401 may acquire the state data for each reference interval. The acquisition unit 401 may acquire the state data from each sensor 21.

The acquisition unit 401 may further acquire one or more key performance indicators (KPIs) regarding the facility 2. The acquisition unit 401 may acquire the KPI for each reference interval. Here, the KPI may be a value indicated by any state data regarding the facility 2, or may be a value calculated using at least one piece of state data. For example, the KPI may be the production amount of the product within a reference period, may be the yield of the product, may be quality, may be profit from the production, or may be the amount of carbon dioxide emissions. In a case where the KPI is different from the state data, the acquisition unit 401 may calculate the KPI by using at least one piece of state data, a preset value (for example, material cost or electricity cost), or the like.

The acquisition unit 401 may further acquire a control parameter applied to the control target equipment 20(T). In a case where a plurality of pieces of equipment 20 are the control target equipment 20(T), the acquisition unit 401 may acquire the control parameter for each piece of control target equipment 20(T). The control parameter may indicate an instruction value for a manipulated variable, or may indicate a target value (also referred to as a set value). The acquisition unit 401 may acquire each control parameter for each reference interval. The acquisition unit 401 may acquire each control parameter from the AI control unit 402 to be described later.

The acquisition unit 401 may supply each piece of the acquired state data to the AI control unit 402 and the prediction unit 404. The acquisition unit 401 may supply each piece of the acquired state data, each KPI, and each control parameter to the selection unit 405 and the storing unit 410. Each piece of the state data supplied from the acquisition unit 401 to the AI control unit 402 and each piece of the state data supplied to the selection unit 405 may be of the same type or may be of different types at least in part.

### AI Control Unit 402

The AI control unit 402 controls the control target equipment 20(T) by using any one of a plurality of learning models 420. The AI control unit 402 according to the present embodiment may have a plurality of learning models 420.

Each learning model 420 outputs a control parameter to be applied to the control target equipment 20(T) in response to the supply of at least one type of state data regarding the facility 2. In a case where a plurality of pieces of equipment 20 are the control target equipment 20(T), each learning model 420 may output the control parameter for each piece of control target equipment 20(T). The learning models 420 may be generated by a conventionally known learning algorithm, may be generated by a common learning algorithm, or may be generated by learning algorithms different from each other. As an example, the learning model 420 may be generated by reinforcement learning and may be trained by using a reward value corresponding to a value of at least one KPI. The reward value may be a value determined by a preset reward function. The reward function may be a function in which the reward value increases as the value of the KPI to be evaluated is closer to a target value. Note that the function is a mapping having a rule that causes each element of a certain set to correspond to each element of another set on a one-to-one basis, and may be a mathematical expression or a table.

The learning data used in the learning processing of the learning model 420 may include a control parameter applied to each piece of control target equipment 20(T) and at least one type of state data regarding the facility 2 before or after the application of the control parameter. The learning data may further include a value of at least one KPI before or after the application of the control parameter. The learning data may be read from the storing unit 410 to be described later. At least one of a learning algorithm, learning data, or a reward function in reinforcement learning may be different among the plurality of learning models 420. Different learning data may mean different types of state data and control parameters included in the learning data, or may mean different acquisition times of the state data and the control parameters.

The AI control unit 402 may supply the state data, which is supplied from the acquisition unit 401, to the learning model 420 (also referred to as a target learning model 420(T)) set as a use target among the plurality of learning models 420, and supply the control parameter, which is output from the target learning model 420(T), to the control target equipment 20(T). In a case where a plurality of pieces of equipment 20 are the control target equipment 20(T), the AI control unit 402 may supply a relevant control parameter for each piece of control target equipment 20(T). The AI control unit 402 may supply, to the target learning model 420(T), the same type of state data as the state data included in the learning data of the target learning model 420(T) among the state data acquired by the acquisition unit 401.

### Input Unit 403

The input unit 403 acquires a signal corresponding to an input operation by a user. The input unit 403 may acquire the signal via an input apparatus such as a keyboard. The input unit 403 may acquire a query signal requesting selection of a learning model 420 recommended (also referred to as a recommended learning model 420(S)) to be used for control of the control target equipment 20(T), and may supply the query signal to the selection unit 405 and the prediction unit 404. The query signal may include identification information (also referred to as a KPI ID) of a KPI designated by the user among a plurality of KPIs regarding the facility 2, and may further include information indicating a reference condition to be satisfied by the KPI. As an example, the reference condition may be that a value of the KPI becomes a value better than a current value, or may be that the value of the KPI falls within a preset reference range. The input unit 403 may acquire a signal indicating approval of use of the selected learning model 420, and may supply the signal to the switching unit 409.

### Prediction Unit 404

The prediction unit 404 predicts the state data at each of a plurality of future time points, based on a history of the state data acquired by the acquisition unit 401. The history of the state data may include state data in chronological order at a plurality of time points, and in the present embodiment, as an example, the history includes state data in chronological order and time information (for example, time when the state data is acquired). The prediction unit 404 may predict the state data by a conventionally known method. For example, the prediction unit 404 may predict future state data by performing regression analysis on past state data, or may predict the future state data by learning processing using learning data including the past state data. The prediction unit 404 may perform prediction with respect to each piece of state data acquired by the acquisition unit 401. The prediction unit 404 may perform prediction in response to the supply of the query signal from the input unit 403. The prediction unit 404 may supply each piece of predicted state data to the determination unit 406.

### Selection Unit 405

The selection unit 405 selects the recommended learning model 420(S) recommended to be used for control of the control target equipment 20(T) from the plurality of learning models 420 in the AI control unit 402. The use of the learning model 420 for control of the control target equipment 20(T) may mean that the control parameter to be applied to the control target equipment 20(T) is acquired from the learning model 420, and in the present embodiment, as an example, the use may mean that the learning model 420 is used as the target learning model 420(T) in the AI control unit 402. The selection unit 405 may select the recommended learning model 420(S) in response to the supply of the query signal from the input unit 403. The selection unit 405 includes a setting unit 4051 and a model selection unit 4052.

### Setting Unit 4051

The setting unit 4051 sets any one of the plurality of KPIs regarding the facility 2 to be switchable as a KPI used (also referred to as a target KPI) for selection of the recommended learning model 420(S). The setting unit 4051 may set, as the target KPI, the KPI indicated by the KPI ID included in the query signal, that is, the KPI designated by the user. The setting unit 4051 may further set a reference condition of the target KPI included in the query signal. In a case where the reference condition is not included in the query signal, the reference condition may be set in advance for the target KPI. The reference condition set in advance may be common regardless of the type of KPI, or may vary depending on the type of KPI. The setting unit 4051 may supply the KPI ID of the set target KPI and the reference condition to the model selection unit 4052.

### Model Selection Unit 4052

The model selection unit 4052 selects, as the recommended learning model 420(S), the learning model 420 recommended to be used for adapting the KPI regarding the facility 2 to the reference condition. The model selection unit 405 may select, as the recommended learning model 420(S), the learning model 420 recommended for adapting the target KPI set by the setting unit 4051 to the reference condition. The recommended learning model 420(S) may be different from the target learning model 420(T) used at a current time point.

The model selection unit 4052 may select the recommended learning model 420(S) based on at least one type of state data acquired by the acquisition unit 401, or may select the recommended learning model 420(S) based on the history of the state data acquired by the acquisition unit 401.

The model selection unit 4052 may select the recommended learning model 420(S) further based on the history of at least one type of past state data, the history of each KPI, and the history of the target learning model 420(T). In addition, the model selection unit 4052 may select the recommended learning model 420(S) further based on the model ID of the target learning model 420(T) at least at the current time point. The model selection unit 4052 may acquire the model ID of a new target learning model 420(T) from the switching unit 409 to be described later every time the target learning model 420(T) is switched.

Here, the history of the KPI may include KPIs in chronological order at a plurality of time points, and in the present embodiment, as an example, the history includes the KPIs in chronological order and time information (for example, time when the KPI is acquired). The history of the target learning model 420(T) may include the models ID of the target learning models 420(T) in chronological order, and in the present embodiment, as an example, the history includes the models ID of the target learning models 420(T) in chronological order and time information (for example, time when the use of the target learning model 420(T) is started).

The model selection unit 4052 according to the present embodiment may be a model in which the learning processing is performed using the learning data including at least one type of state data (that is, the history of the state data), each KPI (that is, the history of the KPI), and the model ID of the target learning model 420(T) (that is, the history of the target learning model 420(T)) at each past time point. In the model of the model selection unit 4052, the learning processing may be performed so as to output the model ID of the recommended learning model 420(S) in response to the supply of the history of at least one type of state data acquired by the acquisition unit 401 and the model ID of the target learning model 420(T) at least at the current time point.

The model selection unit 4052 may be able to calculate, based on the history of the supplied state data, the prediction value of the target KPI at least at a future time point in a case where the recommended learning model 420(S) is set to the target learning model 420(T), and may output the model ID of the recommended learning model 420(S) on condition that the prediction value of the target KPI satisfies the reference condition. In a case where the reference condition is set such that the value of the KPI is a value better than a current value, the model selection unit 4052 may determine whether the prediction value of the target KPI satisfies the reference condition, based on the value of the target KPI acquired by the acquisition unit 401. Note that the model selection unit 4052 may be able to predict the KPI in a steady state after the switching of the target learning model 420(T), and may be able to further predict the KPI in a transition period due to the switching.

The model selection unit 4052 may select the recommended learning model 420(S) based on at least one type of state parameter and at least one type of control parameter acquired by the acquisition unit 401, or may select the recommended learning model 420(S) based on the history of at least one type of state data acquired by the acquisition unit 401 and the history of at least one type of control parameter. In this case, the learning data for the model of the model selection unit 4052 may further include at least one type of control parameter at each past time point. In the model of the model selection unit 4052, the learning processing may be performed so as to output the model ID of the recommended learning model 420(S) in response to the supply of the history of the state data and the history of the control parameter acquired by the acquisition unit 401, and the model ID of the target learning model 420(T) at least at the current time point.

Here, the history of the control parameter may include control parameters in chronological order at a plurality of time points, and in the present embodiment, as an example, the history includes the control parameters in chronological order and time information (for example, time when the control parameter is applied to the control target equipment 20(T)). The control parameter supplied to the model selection unit 4052 and the control parameter included in the learning data of the model selection unit 4052 may be control parameters of the control target equipment 20(T) or may be control parameters of other equipment 20.

In the case of outputting the model ID of the recommended learning model 420(S), the model selection unit 4052 may further output a selection reason of the recommended learning model 420(S). The selection reason may include information indicating a change in KPI (in the present embodiment, the target KPI as an example) predicted in a case where the recommended learning model 420(S) is used. In this case, the selection reason may include a prediction value of the target KPI at least at a future time point. The selection reason may include information indicating that the user has started using the recommended learning model 420(S) from the same past state as the current state. The selection reason may include information indicating a reason why the user has set the recommended learning model 420(S) as the target learning model in a case where the user has started using the recommended learning model 420(S) as the target learning model in the same past state as the current state. In this case, the model selection unit 4052 may be trained by using learning data including a reason why the user has changed the target learning model 420(T).

The model selection unit 4052 may supply the model ID of the selected recommended learning model 420(S) and the selection reason to the determination unit 406.

### Determination Unit 406

The determination unit 406 determines a start timing at which the use of the recommended learning model 420(S) is to be started, based on the state data at each time point predicted by the prediction unit 404. The start timing may be the current time point or may be a time point after the current time point. The determination unit 406 may acquire, from the model selection unit 4052, the prediction value of the target KPI at each future time point in a case where the control target equipment 20(T) is controlled by the control parameter acquired from the recommended learning model 420(S). The determination unit 406 may calculate the value of the KPI at each future time point predicted in a case where the control target equipment 20(T) is controlled by the control parameter acquired from the current target learning model 420(T). The determination unit 406 may compare the value of the KPI at each future time point in a case where the target learning model is continuously used with the value of the KPI at each future time point in a case where the recommended learning model 420(S) is used, and determine, as the start timing, a timing at which the value of the KPI when the recommended learning model 420(S) is used becomes better. Note that the prediction of the KPI by the model selection unit 4052 may include a variation in a transient state due to the start of use of the recommended learning model 420(S), and the determination unit 406 may determine the start timing in consideration of the variation in the transient state. The determination unit 406 may supply, to the generation unit 407, the information indicating the start timing, the model ID of the recommended learning model 420(S), and the selection reason of the recommended learning model 420(S).

### Generation Unit 407

The generation unit 407 generates a report regarding the recommended learning model 420(S). The generated report may include the model ID of the recommended learning model 420(S) and the determined start timing. The report may include the selection reason of the recommended learning model 420(S) in addition to or instead of the start timing. As an example, the report may include text in natural language. The generation unit 407 may generate the report according to the model ID, the start timing, and the selection reason supplied from the determination unit 406. As an example, in a case where the model ID of the recommended learning model 420(S) is “model B” and the target KPI is profit, the report may be content that “Since the temperature has increased by 5 degrees and the flow rate has increased by about 1 ton/h during the past 3 hours, there is a possibility that the profit increases by about 10 to 20 million USD/h by immediately switching to model B”. The generation unit 407 may supply the generated report to the output unit 408. The generation unit 407 may further supply, to the output unit 408, the information indicating the start timing and the model ID of the recommended learning model 420(S).

Note that, in the present embodiment, as an example, the selection unit 405, the determination unit 406, and the generation unit 407 described above may be integrally configured as a generative AI unit 430. The generative AI unit 430 may output a report in natural language including the model ID of the recommended learning model 420(S), the selection reason, and the start timing, in response to the supply of the query signal corresponding to the user operation. The generative AI unit 430 may generate an output sentence in natural language for an input sentence in natural language input from the user via the input unit 403, and supply the output sentence to the output unit 408. The generative AI unit 430 may be generated by performing fine tuning on known generative AI such as chat GPT by using the learning data described above for the model selection unit 4052.

### Output Unit 408

The output unit 408 outputs the model ID of the recommended learning model 420(S). The output unit 408 may output the report generated by the generation unit 407. The output unit 408 may output the report to a display apparatus (not illustrated). Accordingly, a signal indicating approval of using the recommended learning model 420(S) as the target learning model 420(T) may be acquired by the input unit 403 and supplied to the switching unit 409. The output unit 408 may supply, to the switching unit 409, the information indicating the start timing and the model ID of the recommended learning model 420(S).

### Switching Unit 409

The switching unit 409 switches the target learning model 420(T) to the recommended learning model 420(S). In the present embodiment, as an example, the switching unit 409 may switch the target learning model 420(T) in response to supply of an approval signal from the input unit 403. The switching unit 409 may perform switching at the start timing determined by the determination unit 406. The switching unit 409 may set the recommended learning model 420(S) as the target learning model 420(T) by supplying the model ID of the recommended learning model 420(S) to the AI control unit 402. The switching unit 409 may supply the model ID to the storing unit 410 and the selection unit 405.

### Storing Unit 410

The storing unit 410 stores various types of data. The storing unit 410 may store a history of each piece of state data, a history of each control parameter, a history of the target learning model 420(T), and a history of each KPI. The storing unit 410 may store each piece of state data, each control parameter, the target learning model, and each KPI in association with each other for each time. The information stored in the storing unit 410 may be used for learning of the model selection unit 4052 or may be used for learning of the generative AI unit 430.

According to the control support apparatus 4 described above, the recommended learning model 420(S) recommended to be used for control of the control target equipment 20(T) in order to adapt the KPI to the reference condition is selected from the plurality of learning models 420 based on the acquired state data. Therefore, the KPI can be adapted to the reference condition by acquiring the control parameter using the recommended learning model 420(S).

In addition, since the recommended learning model 420(S) is selected based on the history of the acquired state data, the recommended learning model 420(S) for adapting the KPI to the reference condition can be selected with high accuracy as compared with a case where the recommended learning model 420(S) is selected based on the state data at a time point.

In addition, the state data at each of a plurality of future time points is predicted based on the history of the acquired state data, and the start timing at which the use of the recommended learning model 420(S) is to be started is determined based on the predicted state data at each time point. Therefore, the KPI can be reliably adapted to the reference condition by acquiring the control parameter by using the recommended learning model 420(S) from the determined start timing.

In addition, the recommended learning model 420(S) is selected further based on the history of the past state data, the history of the KPI, and the history of the target learning model 420(T). Therefore, as compared with a case where the recommended learning model 420(S) is selected without using the history of the KPI and the history of the target learning model 420(T), the recommended learning model 420(S) for adapting the KPI to the reference condition can be selected with high accuracy.

In addition, the selection unit 405 is provided with a model (in the present embodiment, the model selection unit 4052 as an example) that outputs the model ID of the recommended learning model 420(S) in response to the supply of the history of the state data acquired by the acquisition unit 401 and the model ID of the target learning model 420(T) being used, the model using the learning data including the state data at each past time point, the KPI, and the model ID of the target learning model 420(T). Therefore, the recommended learning model 420(S) for adapting the KPI to the reference condition can be selected with high accuracy.

In addition, in the model of the model selection unit 4052, the learning processing is performed by using the learning data further including the control parameter at each past time point, and the model ID of the recommended learning model 420(S) is output in response to the supply of the history of the state data and the history of the control parameter being acquired, and the model ID of the target learning model 420(T). Therefore, as compared with a case where the recommended learning model 420(S) is selected without using the control parameter, the recommended learning model 420(S) for adapting the KPI to the reference condition can be selected with high accuracy.

In addition, the report including the model ID of the recommended learning model 420(S) and the selection reason of the recommended learning model 420(S) is output. Therefore, whether or not to use the recommended learning model 420(S) can be decided based on the selection reason.

In addition, since the selection reason includes information indicating a change in the KPI predicted in a case where the recommended learning model 420(S) is used, it is possible to decide whether or not to use the recommended learning model 420(S), based on the predicted change in the KPI.

In addition, since any one of the plurality of KPIs regarding the facility 2 is set to be switchable to the target KPI to be used for selecting the recommended learning model 420(S), each set target KPI can be adapted to the reference condition.

In addition, a KPI designated by the user among the plurality of KPIs is set as the target KPI. Therefore, the user can adapt any KPI to the reference condition.

In addition, since the learning model 420 used for control of the control target equipment 20(T) is switched to the recommended learning model 420(S), the control parameter output from the recommended learning model 420(S) can be used for control of the control target equipment 20(T), to adapt the KPI to the reference condition.

### Operation

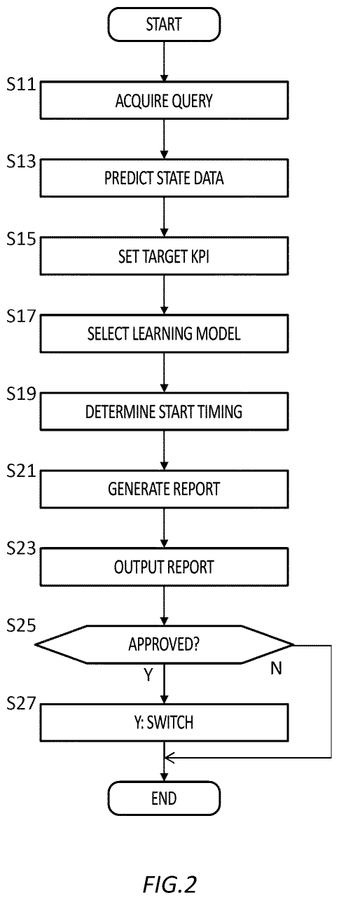

FIG. 2 illustrates an operation of the control support apparatus 4. The control support apparatus 4 switches the target learning model 420(T) by performing the processing of steps S11 to S27. Note that, in parallel with the operation illustrated in this drawing, the acquisition unit 401 may acquire state data from each sensor 21, and the AI control unit 402 may supply the state data to the target learning model 420(T) and supply the control parameter, which is output from the target learning model 420(T), to the control target equipment 20(T) to control the facility 2.

In step S11, the selection unit 405 acquires, from the input unit 403, a query signal requesting selection of the recommended learning model 420(S). The query signal may include the KPI ID of the KPI designated by the user.

In step S13, the prediction unit 404 predicts the state data at each of the plurality of future time points, based on the history of the state data acquired by the acquisition unit 401.

In step S15, the setting unit 4051 sets, as the target KPI, the KPI indicated by the KPI ID included in the query signal. The setting unit 4051 may further set the reference condition of the target KPI included in the query signal.

In step S17, the model selection unit 4052 selects the recommended learning model 420(S) recommended to be used for control of the control target equipment 20(T) in order to adapt the target KPI to the reference condition, based on at least the current state data or the like acquired by the acquisition unit 401. The selection unit 405 may select a single recommended learning model 420(S) or may select a plurality of recommended learning models 420(S). The selection unit 405 may output the model ID of the recommended learning model 420(S) and the selection reason of the recommended learning model 420(S). In the case of selecting a plurality of recommended learning models 420(S), the selection unit 405 may output the model ID of each of the recommended learning models 420(S) and the selection reason thereof.

In step S19, the determination unit 406 determines a start timing at which the use of the recommended learning model 420(S) is to be started, based on the state data at each time point predicted in step S13. In a case where a plurality of recommended learning models 420(S) are selected in step S17, the determination unit 406 may determine a common start timing or may determine separate start timings for the recommended learning models 420(S).

In step S21, the generation unit 407 generates a report including the model ID of the recommended learning model 420(S), the selection reason of the recommended learning model 420(S), and the start timing determined for the recommended learning model 420(S). In a case where a plurality of recommended learning models 420(S) are selected in step S17, the generation unit 407 may generate, for each recommended learning model 420(S), a report including the model ID of the recommended learning model 420(S) and the selection reason of the recommended learning model 420(S). The report may further include the start timing of each recommended learning model 420(S).

In step S23, the output unit 408 outputs the generated report. The output unit 408 may output the report to the display apparatus (not illustrated).

In step S25, the switching unit 409 determines whether or not an approval signal is supplied from the input unit 403. In a case where a plurality of recommended learning models 420(S) are selected in step S17, the switching unit 409 may determine for which recommended learning model 420(S) an approval signal is supplied. If the approval signal is not supplied (step S25; In No), the operation related to the switching of the target learning model 420(T) is ended. If the approval signal is supplied (step S25; Yes), the processing proceeds to step S27.

In step S27, the switching unit 409 switches the target learning model 420(T) by using the recommended learning model 420(S) as a new target learning model 420(T). In a case where a plurality of recommended learning models 420(S) are selected in step S17, the switching unit 409 may set the approved recommended learning model 420(S) as the new target learning model 420(T). The switching unit 409 may perform switching at the start timing determined for the recommended learning model 420(S) in step S19. Accordingly, the control support apparatus 4 ends the operation related to the switching of the target learning model 420(T).

According to the above operation, the report including the model ID of the recommended learning model 420(S) and the selection reason of the recommended learning model 420(S) is output for each of the plurality of recommended learning models 420(S), so that it is possible to decide which recommended learning model 420(S) is to be used, based on the selection reason.

### Operation Example

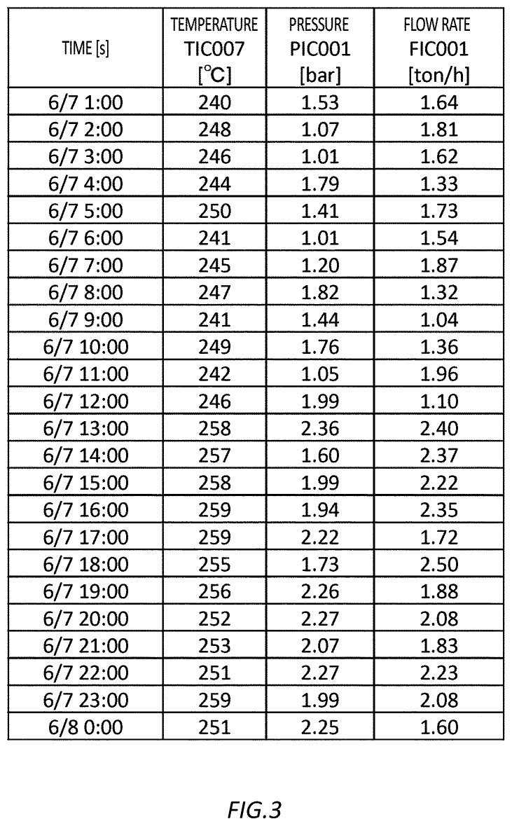

FIG. 3 illustrates a change in the state data acquired by the acquisition unit 401. The acquisition unit 401 may acquire state data of each of temperature, pressure, and flow rate. Identification information such as “TIC007”, “PIC001”, and “FIC001” may be associated with each piece of state data.

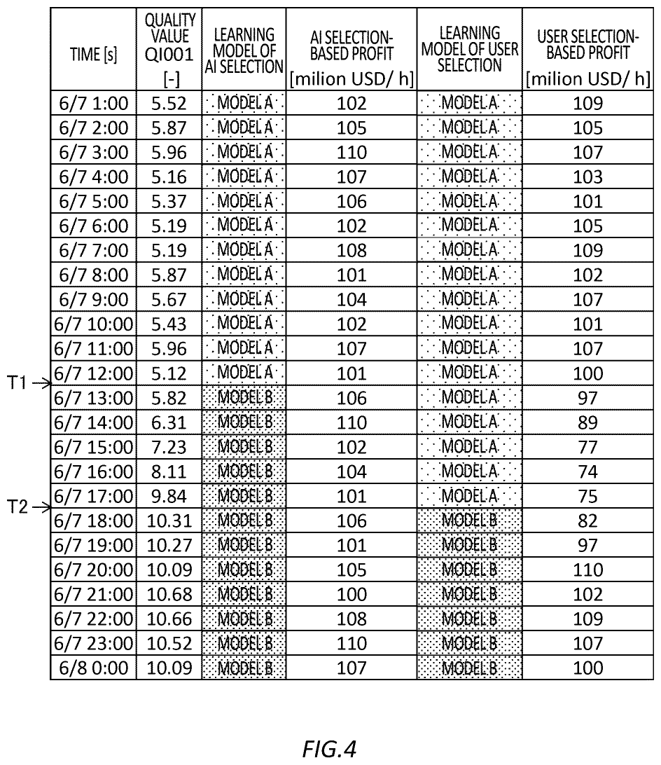

FIG. 4 illustrates a difference in profit depending on the switching timing of the target learning model 420(T). Note that, in this drawing, a case is illustrated in which the learning model 420 of the “model A” is used as the target learning model 420(T) in advance by setting the target KPI to the quality of the product, and the state data changes as illustrated in FIG. 3.

In this case, when the user requests selection of the recommended learning model 420(S) with the target KPI as the profit, the selection unit 405 selects the learning model 420 of the “model B” as the recommended learning model 420(S) as shown in the column of the “learning model of AI selection”, and the determination unit 406 determines the timing of “T1” as the start timing. In a case where the use of the learning model 420 of the “model B” is started at the timing “T1”, the profit per unit time at each time point is as shown in the column of “AI selection-based profit”.

On the other hand, in a case where the user starts using the learning model 420 of the “model B” based on his/her own decision, as an example, the timing of “T2” at which a quality value that is the target KPI exceeds the reference value “10” is set as the start timing as shown in the column of the “learning model of AI selection”. In a case where the use of the learning model 420 of the “model B” is started at the timing “T2”, the profit per unit time at each time point is as shown in the column of “user selection-based profit”.

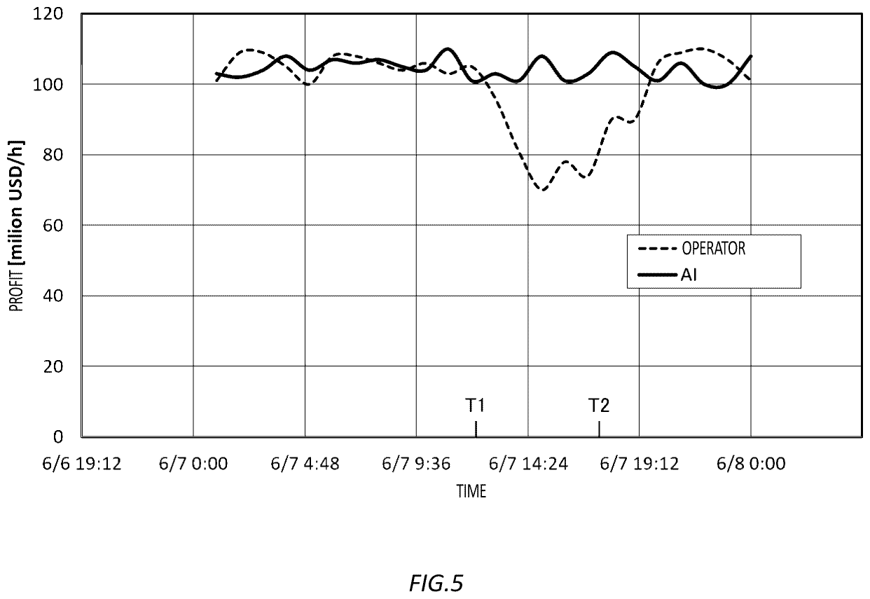

FIG. 5 illustrates a transition of “AI selection-based profit” and “user selection-based profit”. In the drawing, a vertical axis represents the profit per unit time (million USD/h), and a horizontal axis represents time. As illustrated in the drawing, in a case where the learning model 420 of the “model B” selected as the recommended learning model 420(S) by the selection unit 405 is used from the start timing “T1” determined by the determination unit 406 (that is, in the case of the “AI selection” in the drawing), it is possible to prevent a decrease in the KPI emphasized by the user (the profit in the example of the drawing), as compared with a case where the learning model 420 of the “model B” selected by the user is used from the start timing “T2” determined by the user (that is, in the case of the “user selection” in this drawing).

### Example of Dialogue Between User and Generative AI Unit 430

In a case where an input sentence such as “Based on past input values and quality values, please tell me which one of Model A and Model B would be more profitable. Also, please explain the reason.” is input by the user, the generative AI unit 430 may generate a first output sentence such as “The profit increases when switching to the model B. TIC007 has increased by 5 degrees and FIC001 has increased by 1 ton/h in the past 3 hours, so that in a case where Model B is used, there is a possibility of an increase of 10 to 20 million USD/h compared to a case where Model A continues to be used.”.

In addition, in a case where an input sentence such as “Switch to Model B.” is further input for the first output sentence by the user, the generative AI unit 430 may generate a second sentence such as “Instruct to switch to Model B.”, and the model B may be set as the target learning model 420(T) by using the input sentence as the approval signal.

In addition, in a case where an input sentence such as “Model A continues to be used.” is further input for the first output sentence by the user, the generative AI unit 430 may generate an output sentence such as “Please tell me the reason for the decision to continue using Model A. If you tell me the reason, it will be useful for my future decision on model switching.”, and may perform the learning processing of the model selection unit 4052 by using the input reason.

### Modification

### First Modification

In the present modification, in a case where the use of the recommended learning model 420(S) (also referred to as a first recommended learning model 420(S)) is started at the start timing determined by the determination unit 406 (also referred to as a first start timing), the prediction unit 404 may further predict the state data at each of a plurality of time points after the first start timing, based on the history of the state data acquired by the acquisition unit 401. The prediction unit 404 may be trained by using learning data including the history of the state data and the history of the target learning model 420(T), and may predict the state data at each future time point after the first recommended learning model 420(S) is used, based on the history of the state data until the current time point and the history of the target learning model 420(T) until the first start timing. The history of the target learning model 420(T) until the first start timing may be the history of the target learning model 420(T) in a case where the first recommended learning model 420(S) is set as the target learning model 420(T) at the first start timing.

In addition to selecting the first recommended learning model 420(S) based on the state data until the current time point, the model selection unit 4052 may further select another recommended learning model 420(S) (also referred to as a second recommended learning model 420(S)) different from the first recommended learning model 420(S) among the plurality of learning models 420, based on future state data predicted in a case where the first recommended learning model 420(S) is used as the target learning model 420(T).

The model selection unit 4052 may select, as the second recommended learning model 420(S), the learning model 420 recommended to be used for control of the control target equipment 20(T) in order to adapt the target KPI to the reference condition in the state indicated by the state data predicted for a time point after the first start timing. The model selection unit 4052 may select the second recommended learning model 420(S) in a manner similar to that of the first recommended learning model 420(S). The model selection unit 4052 may output the selection reason of the second recommended learning model together with the model ID of the second recommended learning model 420(S).

The determination unit 406 may further determine another start timing (also referred to as a second start timing) at which the use of the second recommended learning model 420(S) is to be started, based on the state data predicted for each time point after the first start timing. The determination unit 406 may determine the second start timing in a manner similar to that of the first start timing.

The generation unit 407 may generate a report further including the model ID of the second recommended learning model 420(S) and the second start timing. The report may further include a selection reason of the second recommended learning model 420(S).

In the first modification described above, in a case where the use of the first recommended learning model 420(S) is started at the first start timing, the state data of each of a plurality of time points after the first start timing is further predicted, and the second recommended learning model 420(S) is further selected which is recommended to be used for the control of the control target equipment 20(T) in order to adapt the KPI to the reference condition in the state indicated by the state data predicted for a time point after the first start timing. In addition, the second start timing at which the use of the second recommended learning model 420(S) is to be started is further determined based on the state data predicted for each time point after the first start timing. Therefore, the KPI can be reliably adapted to the reference condition even at a time point after the first start timing by acquiring the control parameter by using the second recommended learning model 420(S) from the second start timing.

### Second Modification

In the present modification, every time the target learning model 420(T) is switched, the storing unit 410 may store history data in which the model ID of the target learning model 420(T) having started to be used, the history of at least one type of state data before the switching, and the value of the KPI after the switching are associated with each other. The KPI after the switching may be the KPI immediately after the target learning model 420(T) is switched, or may be the KPI at the time point when a reference period has elapsed from the switching time point. The history data may include the control parameter at each past time point.

The model selection unit 4052 may select one history of the state data included in the history data, based on a similarity between the history of the state data acquired by the acquisition unit 401 and each history of the state data included in the history data. The model selection unit 4052 may calculate the similarity between the history of the acquired state data and each history of the state data in the history data. The similarity between the histories of the state data may be a similarity between data sets including values of the state data at a common number of time points for at least one type of common state data, and may be a distance between the data sets (for example, a Euclidean distance or a DTW distance). The model selection unit 4052 may select, from the history data, one history data set having the highest similarity to the acquired history data set. Accordingly, the history of one piece of state data having the highest similarity to the history of the acquired state data is selected.

For the history of the selected one piece of state data, the model selection unit 4052 may select, as the recommended learning model 420(S), the target learning model 420(T) associated with the history of the one piece of state data on condition that the value of the KPI associated in the history data satisfies the reference condition. In a case where the value of the KPI associated with the history of the selected one piece of state data does not satisfy the reference condition, the model selection unit 4052 may select the history of one piece of state data from the data set having the next highest similarity. On condition that the value of the KPI associated with the history of the selected one piece of state data satisfies the reference condition, the model selection unit 4052 may select, as the recommended learning model 420(S), the target learning model 420(T) associated with the history of the one piece of state data. Thereafter, the model selection unit 4052 may select the recommended learning model 420(S) by repeating similar processing until the value of the KPI associated with the history of the selected one piece of state data satisfies the reference condition.

Also in the second modification described above, the recommended learning model 420(S) for adapting the KPI to the reference condition can be selected with high accuracy.

### Another Modification

Note that, in the above-described embodiments and modifications, the setting unit 4051 has been described as setting the KPI designated by the user as the target KPI, but the target KPI may be set by another method. For example, the setting unit 4051 may set, as the target KPI, a KPI that is improvable from the current state among the plurality of KPIs. In this case, the query signal supplied from the input unit 403 may include a signal instructing to set, as the target KPI, any improvable KPI. The setting unit 4051 may detect a KPI that has shown a better value than the current value from the history of each KPI stored in the storing unit 410 and set the KPI as the improvable KPI. The setting unit 4051 may acquire, from the model selection unit 4052, the prediction value of each KPI in a case where each learning model 420 is set to the target learning model 420(T), and may set, as the improvable KPI, the KPI having a better prediction value than the current value. Accordingly, even in a case where the user does not recognize the KPI to be improved, the KPI can be improved and adapted to the reference condition.

In addition, although the model selection unit 4052 and the generative AI unit 430 have been described as already trained, the model selection unit 4052 and the generative AI unit 430 may be further trained by using the stored content of the storing unit 410 as learning data. In this case, the control support apparatus 4 may further include a learning processing unit that performs learning processing on the model selection unit 4052 and the generative AI unit 430.

In addition, the control support apparatus 4 has been described as including the AI control unit 402, the input unit 403, the prediction unit 404, the determination unit 406, the generation unit 407, the switching unit 409, and the storing unit 410, but may not include any of these. In a case where the control support apparatus 4 does not include the AI control unit 402, the user may manually control the control target equipment 20(T) by using the control parameter output from the target learning model 420(T). In a case where the control support apparatus 4 does not include the input unit 403, in response to detection of an improvable KPI, regardless of the query signal, the setting unit 4051 may set the KPI as the target KPI, and the model selection unit 4052 may select the recommended learning model 420(S) every time the target KPI is changed. In addition, the switching unit 409 may automatically switch the recommended learning model 420(S) to the target learning model 420(T). In a case where the control support apparatus 4 does not include the prediction unit 404 and the determination unit 406, the switching unit 409 may switch the recommended learning model 420(S) to the target learning model 420(T) at a timing when a switching approval signal is acquired. In a case where the control support apparatus 4 does not include the generation unit 407, the model ID of the recommended learning model 420(S) may be output to the display apparatus. In a case where the control support apparatus 4 does not include the switching unit 409, the control support apparatus 4 may be used to teach the switching content of the target learning model 420(T) to a new user.

In addition, the selection unit 405 has been described as including the setting unit 4051, but may not include the setting unit 4051. In this case, any KPI among the plurality of KPIs may be fixedly set in advance as the target KPI.

Various embodiments of the present invention may be described with reference to flowcharts and block diagrams, where blocks may represent (1) stages of processes in which operations are executed or (2) sections of apparatuses responsible for executing operations. Certain stages and sections may be implemented by a dedicated circuit, a programmable circuit supplied together with computer-readable instructions stored on computer-readable media, and/or processors supplied together with computer-readable instructions stored on computer-readable media. The dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element or the like such as a flip-flop, a register, a field programmable gate array (FPGA) and a programmable logic array (PLA), or the like.

A computer-readable medium may include any tangible device that can store instructions to be executed by a suitable device, and as a result, the computer-readable medium having instructions stored thereon includes a product including instructions that can be executed in order to create means for executing operations specified in the flowcharts or block diagrams. Examples of the computer-readable medium may include an electronic storage medium, a magnetic storage medium, an optical storage medium, an electromagnetic storage medium, a semiconductor storage medium, and the like. More specific examples of the computer readable medium may include a FLOPPY (registered trademark) disk, a diskette, a hard disk, a random access memory (RAM), a read only memory (ROM), an erasable programmable read only memory (EPROM or a flash memory), an electrically erasable programmable read only memory (EEPROM), a static random access memory (SRAM), a compact disc read only memory (CD-ROM), a digital versatile disk (DVD), a BLU-RAY (registered trademark) disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as Smalltalk (registered trademark), JAVA (registered trademark), C++, or the like, and a conventional procedural programming language such as a “C” programming language or a similar programming language.

The computer-readable instruction may be provided for a processor or programmable circuitry of a programmable data processing apparatus, such as a computer, locally or via a local area network (LAN), a wide area network (WAN) such as the Internet, or the like to execute the computer-readable instruction in order to create means for executing the operations specified in the flowcharts or block diagrams. Here, the computer may be a personal computer (PC), a tablet computer, a smartphone, a workstation, a server computer, or a computer such as a general purpose computer or a special purpose computer, or may be a computer system to which a plurality of computers are connected. Such computer system to which the plurality of computers are connected is also referred to as a distributed computing system, and is a computer in a broad sense. In a distributed computing system, a plurality of computers collectively execute a program by each of the plurality of computers executing part of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. Moreover, which portion of the program each of the plurality of processor is responsible for executing may be determined statically by multiprocessor-aware programming.

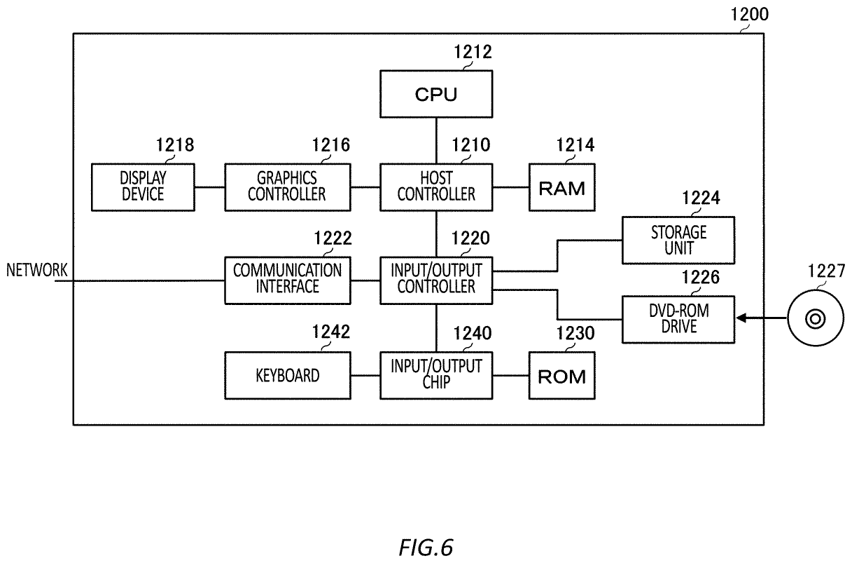

FIG. 6 illustrates an example of a computer 1200 in which a plurality of aspects of the present disclosure may be entirely or partially embodied. A program that is installed in the computer 1200 can cause the computer 1200 to function as one or more “sections” in an operation or an apparatus associated with the embodiment of the present invention, or cause the computer 1200 to perform the operation or the one or more sections thereof, and/or cause the computer 1200 to perform processes of the embodiment of the present invention or steps thereof. Such a program may be performed by a CPU 1212 so as to cause the computer 1200 to perform certain operations associated with some or all of the blocks of flowcharts and block diagrams described herein.

The computer 1200 in accordance with the present embodiment includes a CPU 1212, a RAM 1214, a graphics controller 1216, and a display device 1218, which are mutually connected by a host controller 1210. The computer 1200 also includes a storage unit 1224 such as a communication interface 1222, a hard disk drive, or the like, an input/output unit such as a DVD-ROM drive 1226 and the IC card drive, which are connected to a host controller 1210 via an input/output controller 1220. The computer also includes legacy input/output units such as an ROM 1230 and a keyboard 1242, which are connected to the input/output controller 1220 via an input/output chip 1240.

The CPU 1212 operates according to programs stored in the ROM 1230 and the RAM 1214, thereby controlling each unit. The graphics controller 1216 obtains image data generated by the CPU 1212 on a frame buffer or the like provided in the RAM 1214 or in itself, and causes the image data to be displayed on a display device 1218.

The communication interface 1222 communicates with other electronic devices via a network. The storage unit 1224 stores the program and data used by the CPU 1212 within the computer 1200. The DVD-ROM drive 1226 reads the program or data from the DVD-ROM 1227 and provides the program or data to the storage unit 1224 via the RAM 1214. The IC card drive reads the programs and the data from the IC card, and/or writes the programs and the data to the IC card.

The ROM 1230 stores therein a boot program or the like that is performed by the computer 1200 at the time of activation, and/or a program depending on the hardware of the computer 1200. The input/output chip 1240 may also connect various input/output units to the input/output controller 1220 via a parallel port, a serial port, a keyboard port, a mouse port, or the like.

Programs are provided by a computer readable medium such as the DVD-ROM 1227 or the IC card. The program is read from the computer readable medium, is installed on a storage unit 1224, a RAM 1214, or a ROM 1230, which are an example of a computer readable medium, and is executed by the CPU 1212. Information processing written in these programs is read by the computer 1200, and provides cooperation between the programs and the various types of hardware resources described above. An apparatus or method may be constituted by realizing the operation or processing of information in accordance with the usage of the computer 1200.

For example, when communication is performed between the computer 1200 and an external device, the CPU 1212 may perform a communication program loaded onto the RAM 1214 to instruct communication processing to the communication interface 1222, based on the processing described in the communication program. The communication interface 1222 reads the transmission data stored in a transmission buffer processing region provided on a recording medium such as a RAM 1214, a storage unit 1224, a DVD-ROM 1227, or an IC card under the control of a CPU 1212, transmits the read transmission data to the network, or writes the reception data received from the network to a reception buffer processing region or the like provided on a recording medium.

In addition, the CPU 1212 may cause the RAM 1214 to read all or a necessary part of a file or database stored in an external recording medium such as the storage unit 1224, the DVD-ROM drive 1226 (DVD-ROM 1227), the IC card, or the like, and may execute various types of processing on data on the RAM 1214. The CPU 1212 may then write back the processed data to the external recording medium.

Various types of information such as various types of programs, data, tables, and databases may be stored in a recording medium and subjected to information processing. The CPU 1212 may perform various types of processing on the data read from the RAM 1214, which includes various types of operations, processing of information, condition judging, conditional branch, unconditional branch, search/replace of information, etc., as described throughout this disclosure and designated by an instruction sequence of programs, and writes the result back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may retrieve, out of the plurality of entries, an entry with the attribute value of the first attribute specified that meets a condition, read the attribute value of the second attribute stored in said entry, and thereby acquiring the attribute value of the second attribute associated with the first attribute satisfying a predetermined condition.

The above-explained program or software modules may be stored in the computer readable media on or near the computer 1200. In addition, a recording medium such as a hard disk or a RAM provided in a server system connected to a dedicated communication network or the Internet can be used as the computer readable media, thereby providing the program to the computer 1200 via the network.

While the present invention has been described by way of the embodiments, the technical scope of the present invention is not limited to the scope described in the above-described embodiments. It is apparent to persons skilled in the art that various alterations or improvements can be made to the above-described embodiments. It is also apparent from the description of the claims that the form to which such alterations or improvements are made can be included in the technical scope of the present invention.

It should be noted that the operations, procedures, steps, stages, and the like of each process performed by an apparatus, system, program, and method shown in the claims, the specification, or the drawings can be realized in any order as long as the order is not indicated by “prior to,” “before,” or the like and as long as the output from a previous process is not used in a later process. Even if the operation flow is described by using phrases such as “first” or “next” for the sake of convenience in the claims, specification, and drawings, it does not necessarily mean that the process must be performed in this order.

### Explanation of References

1: system; 2: facility; 4: control support apparatus; 20: equipment; 20(T): control target equipment; 21: sensor; 401: acquisition unit; 402: AI control unit; 403: input unit; 404: prediction unit; 405: selection unit; 406: determination unit; 407: generation unit; 408: output unit; 409: switching unit; 410: storing unit; 420: learning model; 420(T): target learning model; 420(S): recommended learning model; 430: generative AI unit; 1200: computer; 1210: host controller; 1212: CPU; 1214: RAM; 1216: graphics controller; 1218: display device; 1220: input/output controller; 1222: communication interface; 1224: storage unit; 1226: DVD-ROM drive; 1227: DVD-ROM; 1230: ROM; 1240: input/output chip; 1242: keyboard; 4051: setting unit; and 4052: model selection unit.

What is claimed is:

1. An apparatus comprising:
an acquisition unit which acquires state data regarding a facility;
a selection unit which selects, among a plurality of learning models that output a control parameter to be applied to a control target in the facility, a recommended learning model recommended to be used for control of the control target in order to adapt a KPI regarding the facility to a reference condition, based on the state data acquired by the acquisition unit, in response to supply of the state data regarding the facility; and
an output unit which outputs identification information of the recommended learning model.

2. The apparatus according to claim 1, wherein the selection unit selects the recommended learning model based on a history of the state data acquired by the acquisition unit.

3. The apparatus according to claim 2, further comprising:
a prediction unit which predicts state data at each of a plurality of future time points based on the history of the state data acquired by the acquisition unit;
a determination unit which determines a start timing at which use of the recommended learning model is to be started, based on predicted state data at each time point; and
a generation unit which generates a report including identification information of the recommended learning model and the start timing, wherein
the output unit outputs the report.

4. The apparatus according to claim 3, wherein
the prediction unit further predicts state data at each of a plurality of time points after the start timing in a case where use of the recommended learning model is started at the start timing,
the selection unit further selects, among the plurality of learning models, another recommended learning model that is different from the recommended learning model and that is recommended to be used for control of the control target in order to adapt the KPI to the reference condition in a state indicated by state data predicted for a time point after the start timing,
the determination unit further determines another start timing at which use of the another recommended learning model is to be started, based on state data predicted for each time point after the start timing, and
the generation unit generates a report further including identification information of the another recommended learning model and the another start timing.

5. The apparatus according to claim 2, wherein the selection unit selects the recommended learning model, further based on a history of the state data in a past, a history of the KPI, and a history of a learning model used for control of the control target.

6. The apparatus according to claim 5, wherein the selection unit includes a model that is subjected to learning processing using learning data including state data at each past time point, the KPI, and identification information of a learning model used for control of the control target, and outputs identification information of the recommended learning model in response to supply of a history of the state data acquired by the acquisition unit and identification information of a learning model used for control of the control target.

7. The apparatus according to claim 6, wherein
the acquisition unit further acquires a control parameter applied to the control target, and
the model is subjected to learning processing using learning data further including a control parameter at each past time point, and outputs identification information of the recommended learning model in response to supply of a history of the state data and a history of the control parameter acquired by the acquisition unit, and identification information of a learning model used for control of the control target.

8. The apparatus according to claim 5, further comprising
a storing unit which stores history data in which identification information of a learning model having started to be used, a history of the state data before switching, and a value of the KPI after switching are associated with each other, every time a learning model used for control of the control target is switched, wherein
the selection unit
selects one history of the state data included in the history data, based on a similarity between a history of the state data acquired by the acquisition unit and each history of the state data included in the history data, and
on condition that a value of the KPI associated with one history of the state data in the history data satisfies the reference condition, selects, as the recommended learning model, a learning model associated with the one history of the state data.

9. The apparatus according to claim 1, further comprising
a generation unit which generates a report including identification information of the recommended learning model and a reason why the selection unit has selected the recommended learning model, wherein
the output unit outputs the report.

10. The apparatus according to claim 9, wherein
the selection unit selects a plurality of recommended learning models including the recommended learning model, and
the generation unit generates, for each recommended learning model, the report including identification information of the recommended learning model and a selection reason of the recommended learning model.

11. The apparatus according to claim 9, wherein the reason includes information indicating a change in the KPI predicted in a case where the recommended learning model is used.

12. The apparatus according to any one of claims 1 to 11, wherein the selection unit includes a setting unit which sets any of a plurality of KPIs regarding the facility to be switchable as the KPI used for selection of the recommended learning model.

13. The apparatus according to claim 12, wherein the setting unit sets a KPI designated by a user among the plurality of KPIs as the KPI used for selection of the recommended learning model.

14. The apparatus according to claim 12, wherein the setting unit sets, as the KPI used for selection of the recommended learning model, a KPI that is improvable from a current state among the plurality of KPIs.

15. The apparatus according to claim 1, further comprising a switching unit which switches a learning model used for control of the control target to the recommended learning model.

16. A method comprising:
acquiring state data regarding a facility;
selecting, among a plurality of learning models that output a control parameter to be applied to a control target in the facility, a recommended learning model recommended to be used for control of the control target in order to adapt a KPI regarding the facility to a reference condition, based on the state data acquired in the acquiring, in response to supply of state data regarding the facility; and
outputting identification information of the recommended learning model.

17. A non-transitory computer readable medium having recorded thereon a program for causing a computer to function as:
when executed by the computer,
an acquisition unit which acquires state data regarding a facility;
a selection unit which selects, among a plurality of learning models that output a control parameter to be applied to a control target in the facility, a recommended learning model recommended to be used for control of the control target in order to adapt a KPI regarding the facility to a reference condition, based on the state data acquired by the acquisition unit, in response to supply of state data regarding the facility; and
an output unit which outputs identification information of the recommended learning model.
